(19) United States
(12) Patent Application Publication
(10) Pub. No.: US 2006/0132666 A1
(43) Pub. Date: Jun. 22, 2006

(54) Substrate for display device and manufacturing method thereof

(75) Inventors: Hirotaka Niiya, Kyoto (JP); Yoshitaka Okumoto, Kashihara-shi (JP); Satoru Kishimoto, Yamatokoriyama-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/312,523

(22) Filed: Dec. 21, 2005

(30) Foreign Application Priority Data
Dec. 22, 2004 (JP) 2004-371747

(51) Int. Cl. G02F 1/136

(52) U.S. Cl. 349/41; 427/58; 349/42

(57) ABSTRACT

To provide: a substrate for display device, in which generation of an area not filled with liquid material and mixing (color mixing) between liquid materials are suppressed when a functional film is formed by a method using liquid material, such as the IJ method, and display quality in display device is improved; a manufacturing method thereof; and a color filter substrate, a thin film transistor array substrate, a liquid crystal display device and an organic electroluminescent display device each comprising the substrate for display device. A substrate for display device having a structure with a functional film partitioned by a bank on the substrate, the functional film being represented by a contour pattern extending to a corner inside a bank.

### REFERENCE TO RELATED APPLICATION

This Nonprovisional application claims priority under 35 U.S.C. § 119(a) on Patent Application No. 2004-371747 filed in Japan on Dec. 22, 2004 and the entire contents of which are hereby incorporated by reference.

### BACKGROUD OF THE INVENTION

1. Field of the Invention

The present invention relates to a substrate for display device, a manufacturing method thereof, a color filter substrate, a thin film transistor array substrate, a liquid crystal display device and an organic electroluminescent display device. More specifically, the present invention relates to a substrate for display device used for a liquid crystal TV and the like, and a method for manufacturing thereof, and a color filter substrate, a thin film transistor array substrate, a liquid crystal display device and an organic electroluminescent display device each comprising the substrate for display device.

2. Description of the Related Art

Recently, there is growing demand for a liquid crystal display, especially a color liquid crystal display with expansion of market of liquid crystal TV. For much more spread of this color liquid crystal display in future, reduction of production costs are needed. Especially, it is necessary to reduce manufacturing costs of a color filter (CF) substrate produced with high costs. The CF substrate generally has a structure in which many colored layers (color filters) consisted of three primary colors of light: red (R), green (G), and blue (B) are respectively formed in pixels on a transparent substrate. Such a CF substrate is used for a liquid crystal display device and the like. For effective reduction in manufacturing costs of this CF substrate, it was important to improve formation efficiency of the colored layer.

A pigment dispersion method, a dyeing process and the like are known as a formation method of the colored layer in conventional CF substrates. The pigment dispersion method is a method of aplying a photosensitive base material, in which a pigment is dispersed, on a transparent substrate, and forming a colored layer pattern by exposure and development. The dyeing process is a process of forming a pattern by exposing and developing a dyeing base material applied on a transparent substrate, and dyeing the pattern to give a colored layer. These manufacturing methods needs repeat of each step, that is, application, exposure, and development steps for every color. Therefore, the process is difficult to be simplified. And a spin coat in the application step causes greater loss of the material. An electrode position method, a printing method and the like may be mentioned as a method for forming the colored layer other than the above methods. The electrode position method is a method of forming a transparent electrode pattern on a transparent substrate, and soaking the substrate in electrolyte coating solution containing a pigment, a resin, electrolyte and the like to electrodeposit each color. The printing method is a method of dispersing a pigment on a transparent substrate, and printing the pigment on the substrate to form a colored layer. However, the electrode position method limits a pattern shape of the colored layer which can be formed. The printing method also has a difficulty in formation of a high-definition pattern.

With such problems, a formation method of the colored layer using an ink jet (IJ) method is currently brought to attention. If the colored layer is formed on the CF substrate by the IJ method, the use amount of the ink can be reduced (the ink use efficiency can be improved), because an ink jet head ejects the ink (amaterial for colored layer) while moving over a transparent substrate to form a colored layer pattern directly on the substrate. And the simplified process permits reduction in manufacturing costs because the IJ method needs neither exposure nor development steps.

If the colored layer is formed by such an IJ method, a bank (projection) is provided on a substrate constituting a CF substrate in order to prevent inks (liquid material) from mixing with each other between adjacent dots. And the bank usually has a hydrophobicity in order to prevent the ink mixing more effectively. As shown in FIG. 7A, an ink 12 is ejected from a nozzle of an ink jet head linearly at a predetermined space, and the droplet added dropwise inside a bank 11 spreads over the whole dot.

The dot is generally a square, such as a rectangle, but the droplet of the ink 12 tends to have a circular shape because of the surface tension. Therefore, the ink 12 is hard to spread uniformly to a corner inside the bank 11 when it spreads inside the bank 11. Accordingly, as shown in FIG. 7B, a corner of a dot (corner inside the bank 11) of a colored layer 23a formed by the IJ method often has a thinner film thickness than desired film thickness, and the colored layer 23a has unevenness in film thickness inside the dot. If such unevenness in film thickness is remarkably generated, the colored layer 23a is not formed at the corner of the dot, which causes a phenomenon of “void” meaning that light from a light source such as a backlight passes through a colored filter without being colored fully. As mentioned above, the formation of the colored layer 23a by the IJ method leaves room for improvement in order to improve display quality of a display device.

With the above improvement, as shown in FIG. 8A, if a more increased amount of the ink 12 is ejected inside the bank 11 in order to fill the corner inside the bank 11 with the ink 12, the ink 12 can spread to the corner inside the bank 11, but the amount of the ink 12 around the center inside the bank 11 also increases. Therefore, the ink 12 spreads on the bank 11, which might cause the ink mixing between the adjacent dots, as shown in FIG. 8B.

A method is proposed in which an ink is ejected inside and on a bank in order to fill a corner inside the bank with the ink (For example, refer to the Japanese patent No. 3124718, page 1). However, this method might cause an ink mixing between dots, because the ink is ejected on the bank partitioning dots. And in the method, a sufficient film thickness as the colored layer might not be obtained because the ink might remains on the bank, and therefore the ink amount inside the bank decreases. And if the ink solidifies on the bank, the film thickness of the bank increases due to the solidified ink, as compared with that of the bank on which no ink remains. Therefore, when such a CF substrate is used for a liquid crystal display device, a leakage might occur between a pixel electrode formed on the CF substrate and a pixel electrode formed on the opposed substrate.

### SUMMARY OF THE INVENTION

The present invention has made in view of the above-mentioned state of the art. The present invention has an object to provide: a substrate for display device, in which generation of an area not filled with liquid material and mixing (color mixing) between liquid materials are suppressed when a functional film is formed by a method using liquid material, such as the IJ method, and display quality in display device can be improved; a manufacturing method thereof; and a color filter substrate, a thin film transistor array substrate, a liquid crystal display device and an organic electroluminescent display device each comprising the substrate for display device.

The present inventors have made various investigations about a substrate for display device which can improve display quality in display device by suppressing phenomenon such as the void if a functional film is formed by a method using liquid material such as the ink jet method. And they have noted an ejection pattern when the liquid material for functional film is ejected inside a bank. And they have found that if the liquid material for function film is ejected at least at a corner inside the bank, the generation of an area not filled with liquid material can be suppressed, because the corner of the bank is filled with the liquid material while suppressing the mixing (color mixing) between the liquid materials. That is, they have found that if the liquid material for functional film is ejected at least at the corner inside the bank, uniformity of the film thickness in the functional film can be improved, and the functional film is represented by a contour pattern extending to the corner inside the bank, which gives a substrate for display device in which phenomenon such as the void are suppressed. As a result, they have admirably resolved the above-mentioned problems, and completed the present invention.

That is, the present invention relates to a substrate for display device having a structure with a functional film partitioned by a bank on the substrate, the functional film being represented by a contour pattern extending to a corner inside a bank.

### BRIEF DESCRIPTION OF THE DRAWINGS

FIG. 1A is a plane view schematically showing a position at which a droplet of liquid material (ink) for functional film is ejected in Embodiment 1.

FIG. 1B is a plane view schematically showing, with a contour pattern, a film thickness of a colored layer formed in Embodiment 1.

FIG. 2A is a plan view schematically showing a dot-matrix pattern of a colored layer formed by a black matrix having a light-shielding part for a thin film transistor (TFT) at a corner.

FIG. 2B is a plan view schematically showing a dot-matrix pattern of a colored layer formed by a black matrix having a light-shielding part for a thin film transistor (TFT) at a corner and having a light-shielding part for storage capacitor wiring at the center.

FIG. 3A is a plane view schematically showing a position at which a droplet of liquid material (ink) for functional film is ejected in Embodiment 2.

FIG. 3B is a plane view schematically showing, with a contour pattern, a film thickness of a colored layer formed in Embodiment 2.

FIG. 4A is a plane view schematically showing a position at which a droplet of liquid material (ink) for functional film is ejected in Embodiment 3.

FIG. 4B is a plane view schematically showing, with a contour pattern, a film thickness of a colored layer formed in Embodiment 3.

FIG. 5A is a plane view schematically showing a position at which a droplet of liquid material (ink) for functional film is ejected in Embodiment 4.

FIG. 5B is a plane view schematically showing, with a contour pattern, a film thickness of a colored layer formed in Embodiment 4.

FIG. 6A is a plane view schematically showing a position at which a droplet of liquid material (ink) for functional film is ejected in Embodiment 5.

FIG. 6B is a plane view schematically showing, with a contour pattern, a film thickness of a colored layer formed in Embodiment 5.

FIG. 7A is a plane view schematically showing a conventional position at which a droplet of liquid material (ink) for functional film is ejected.

FIG. 7B is a plane view schematically showing, with a contour pattern, a film thickness of a colored layer formed after the ink shown in FIG. 7A dries.

Each dotted line in FIGS. 7A and 7B shows a contour of the colored layer 23a.

FIG. 8A is a plane view schematically showing a conventional position at which a droplet of liquid material (ink) for functional film is ejected.

FIG. 8B is a plane view schematically showing, with a contour pattern, a film thickness of a colored layer formed after the ink shown in FIG. 8A dries.

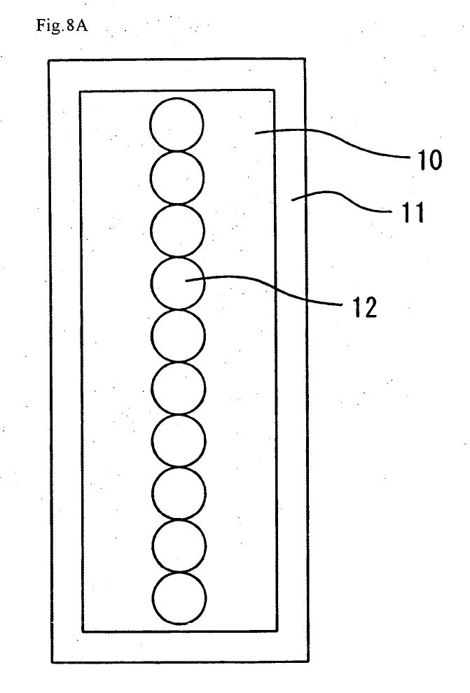

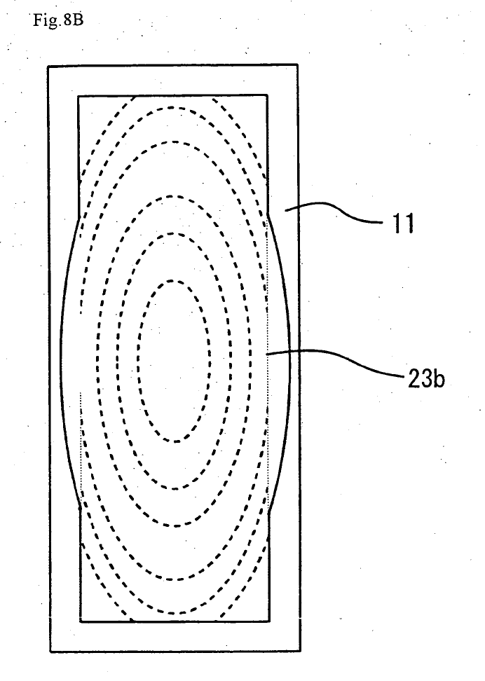

Each dotted line in FIGS. 8A and 8B shows a contour of a colored layer 23b.

### EXPLANATION OF SYMBOLS AND NUMERALS

10: Glass Substrate

11: Black Matrix (BM)

11a: Light-shielding part for TFT in the BM

11b: Light-shielding part for storage capacitor wiring in the BM

12: Ink

13a to 13e, 23a and 23b: Colored Layer

21: Ink jet head

22: Ink jet nozzle

### DESCRIPTION OF THE PREFERRED EMBODIMENTS

The present invention relates to a substrate for display device having a structure with a functional film partitioned by a bank on the substrate, the functional film being represented by a contour pattern extending to a corner inside a bank.

The above-mentioned functional film is not especially limited as long as it is formed inside the bank by an application method using liquid material such as the ink jet method. For example, a colored layer is formed as a functional film if the substrate for display device of the present invention is used as a color filter substrate for liquid crystal display device; a pixel electrode is formed as a functional film if used as a thin film transistor (TFT) array substrate; and a luminous layer or a hole transfer layer is formed as a functional film if used as an organic electroluminescent panel for organic electroluminescent (EL) display device.

The above-mentioned bank is not especially limited as long as it is a structure (projection) for partitioning a plurality of areas each forming a functional film. The bank may be formed from a photosensitive resin and the like, for example. Example of the above-mentioned structure with a functional film partitioned by a bank includes a structure, in which each functional film is disposed in an arrangement, such as diagonal arrangement, delta arrangement, and stripe arrangement, and the bank is disposed between the functional films.

According to the present invention, the above-mentioned functional film is represented by a contour pattern extending to a corner inside the bank. That is, the contour pattern according to the present invention satisfies the following condition: if contour patterns are drawn by connecting points having the same film thickness, based on a uniform film thickness interval, of the functional film inside the bank in order that two or more contour patterns are drawn at the corner inside the bank, the average distance between at least one pair of adjacent contours among the contours drawn at the corner inside the bank is longer than that between the innermost two contours inside the bank. The above-mentioned corner inside the bank means an area formed on the bank side when midpoints of each side constituting the bank pattern are connected between the adjacent sides with a straight line. However, it does not contain a neighborhood of a corner having 180° or more of an interior angle of the functional film side (inner side). For example, a square-shaped bank pattern has four corners, and a substantially square-shaped pattern, in which one corner of four corners has a rectangular overhanging part, has five corners if it is formed.

In a conventional substrate for display device, if the functional film is formed by an application method using liquid material such as the ink jet method, the contour pattern of the functional film depends on a pattern and surface property of a bank, and a pattern when a droplet of liquid material is added dropwise, and the like. However, the contour basically tends to be formed in a concentric pattern centering on the center inside the bank due to a surface tension of-the droplet of liquid material. Therefore, the functional film having an insufficient film thickness is formed at the corner inside the bank. On the other hand, according to the present invention, the functional film is formed so as to have a film thickness thicker than that of a conventional functional film at the center inside the bank by employing the method of ejecting (adding dropwise) the liquid material at the corner. Therefore, the functional film is represented by the contour pattern extending to the corner inside the bank.

It is preferable that the functional film is formed from solidified ink. If the ink jet method is employed for formation of the functional film, the corner inside the bank might not be filled with the functional film generally. However, the method of ejecting (adding dropwise) the liquid material for functional film at the corner permits the embodiment of the present invention. In this case, effects of the present invention can be exhibited while taking advantage of the ink jet method in the manufacturing. The solidified ink is not especially limited as long as it can be produced by drying and solidifying liquid material (ink) capable of being ejected with an ink jet device.

It is preferable that the bank is formed from a hydrophobic material. If the bank is formed from a hydrophobic material, an area not filled with the functional film is easily formed at the corner inside the bank. However, the method of ejecting (adding dropwise) the liquid material for functional film at the corner permits an embodiment of the present invention. In this case, effects of the present invention can be exhibited while effectively preventing liquid material from overreaching the bank and causing the color mixing. As the above-mentioned bank formed from a hydrophobic material, for example, the bank having a surface with which a hydrophobicity is given by a plasma treatment using fluorine gas, or the bank formed from a hydrophobic material may be preferably used. The fluorine gas used for the plasma treatment is not especially limited as long as it contains a fluorine atom. And preferably used is a gas such as CF₄, SF₆, CHF₃, C₂F₆ or such a gas diluted with N₂, He, and the like.

The bank preferably has a hydrophobicity showing a contact angle of 50° or more to the liquid material for functional film.

It is preferable that the bank has a structure with a chamfered corner. An area often having an insufficient film thickness can be previously filled with the bank, because the corner inside the bank can be chamfered with straight line or curve corresponding to a shape of the droplet of the liquid material for functional film which easily becomes a globular shape due to the surface tension. Therefore, the void at the corner inside the bank can be prevented, which improves display qualityof a display device using the substrate for display device of the present invention. The chamfered shape is not especially limited, and, for example, R chamfering and C chamfering may be mentioned.

It is preferable that the bank is formed from a light-shielding material. Such a bank can be used as a light-shielding member (black matrix) for partitioning areas forming the functional films. As the light-shielding material, a photosensitive resin containing a black pigment and the like may be mentioned

The configuration of the substrate for display device of the present invention is not especially limited as long as the substrate comprises the above-mentioned components. And the substrate may or may not comprise other components.

The present invention also relates to a method for manufacturing a substrate for display device having a structure with a functional film partitioned with a bank on the substrate, the functional film being formed on the substrate by ejecting liquid material for the functional film at least at a corner inside the bank. Such a manufacturing method of the present invention enables the liquid material for functional film to spread to the corner inside the bank, and therefore a sufficient film thickness of the functional film can be secured at the corner. Therefore, the substrate for display device of the present invention can be manufactured. And the use of the substrate for display device of the present invention can improve display quality of a display device by suppressing phenomenon such as the void effectively.

Examples of the liquid material for functional film include (1) a colored material produced by dispersing a pigment in a dispersion medium, (2) an electrode material such as: a material produced by dispersing conductive particulates containing silver, copper, gold, palladium, nickel, an alloy thereof, or indium oxide tin (ITO) and the like in a dispersion medium; a material generating a metal by a chemical reaction such as reduction after being applied; and a conductive polymer or a (dispersed) solution in which the conductive polymer is solved (dispersed) , (3) organic semiconductor materials, such as PEDOT (polyethylene dioxy thiophene) used for injecting a carrier to a luminous layer material for organic electroluminescence and a luminous layer. They are used corresponding to the kind of the functional film. Among them, the material having a property suitable for application by the ink jet method is preferable. The condition of ejection of the liquid material is not especially limited, and it may be suitably adjusted according to a desired film thickness of the functional film, composition and property of the liquid material, or material of the substrate.

It is preferable that the liquid material is ejected with an ink jet device. In such a case, the use efficiency of the liquid material improves and the manufacturing process can be simplified. Therefore, the manufacturing costs of the substrate for display device can be reduced.

It is preferable that the liquid material is ejected such that an ejected amount at the center is less than that at the corner inside the bank. That is, the droplets of the liquid material are ejected at smaller distances near the corner inside the bank, and ejected at larger distances near the center inside the bank. The ejection in such a manner prevents the film thickness from becoming too thick at the center where the liquid material easily gathers. Therefore, the functional film with more uniform film thickness can be formed.

It is preferable that the liquid material is ejected from a long side if the functional film has an elongated shape. If the ejection is performed in such a manner, the distance between the droplets in a direction of a narrow side of the functional film can be easily adjusted, as compared the case where the liquid material is ejected from the narrow side of the functional film. Furthermore, the number of scanning of the ejection device can be reduced. For example, if an ink jet head is arranged parallel to the long side of the functional film (the long side of the bank) and the scanning is performed from one long side to the other long side while keeping the ink jet head parallel to the long side of the bank, the liquid material can be ejected in one scanning while adjusting the distance between the droplets in the direction of the narrow side of the bank by controlling the ejection timing. On the other hand, the distance between the droplets in the direction of the long side of the bank may be longer than that in the direction of the narrow side of the bank, considering effects of the invention in which the corner inside the bank is filled with the liquid material while suppressing the mixing (color mixing) between the liquid materials. Therefore, it is a minor inconvenience that the ejection is carried out at regular distances using the distance between the nozzles formed in the ink jet head.

It is preferable that the liquid material is ejected in two steps of firstly ejecting the liquid material from one side of facing two sides in the bank to a middle inside the bank, and secondly ejecting the liquid material at an unejected area inside the bank from the other side.

The droplet added dropwise to the substrate by the ejection tends to be drawn toward the droplet previously added dropwise when they contact with each other. Therefore, if the functional film is formed by the ink ejected in one scanning only from one side, the liquid material easily gathers at the corner on the side from which the scanning begins and the corner on facing the other side tends to have a smaller liquid amount. However, if the above ejection method is employed, the liquid material can effectively gather at the corners on both sides of one side and the other side, and the film thickness at the corner of the functional film can be sufficiently secured, which can prevent the void effectively.

The present invention relates to a substrate for display device manufactured by the method for manufacturing the substrate for display device. The substrate for display device of the present invention is preferably used, for example, as a color filter substrate, in which the functional film serves as a colored layer, a thin film transistor array substrate, in which the functional film serves as a pixel electrode, or an organic electroluminescent display panel, in which the functional film serves as a luminous layer. The use of such substrates can improve display quality of a display device, because the generation of the area unfilled with the liquid material and the mixing (color mixing) between the liquid materials can be suppressed. The color filter substrate generally has a configuration in which a colored layer (color filter) of three colors consisted of red, green and blue, and a bank partitioning the colored layers are each provided in a pixel on the substrate, and thereon stacked are a protective film, a common electrode, an alignment film and the like. The thin film transistor array substrate generally has a configuration in which a pixel electrode, a bank partitioning the pixel electrodes, and a thin film transistor (TFT) driving each pixel electrode are each provided in a dot (subpixel corresponding to each color) on the substrate. And the organic electroluminescent display panel generally has a configuration in which an organic layer, a bank partitioning the organic layers are each provided in a pixel on the substrate, and a pair of electrodes for driving are provided with the organic layer therebetween. The organic layer generally contains a luminous layer of three colors, which emits red, green, and blue colors, and, if necessary, contains an electronic transporting layer, a hole transporting layer and the like.

The present invention relates to a liquid crystal display device comprising the color filter substrate and/or the thin film transistor array substrate, or an organic electroluminescent display device comprising the substrate for display device of the present invention. Such display devices can improve display quality because the phenomenon such as the void is effectively prevented.

In the substrate for display device of the present invention, the functional film is represented by the contour pattern extending to the corner inside the bank. Therefore, the generation of the area unfilled with the liquid material at the corner inside the bank and the mixing (color mixing) between the liquid materials can be suppressed if the functional film is formed by a method using the liquid material, such as the ink jet method. Accordingly, the substrate for display device of the present invention can improve display quality of a display device.

The present invention will, hereinafter, be described in more detail with reference to Embodiments, but the present invention is not limited to these Embodiments.

### EMBODIMENT 1

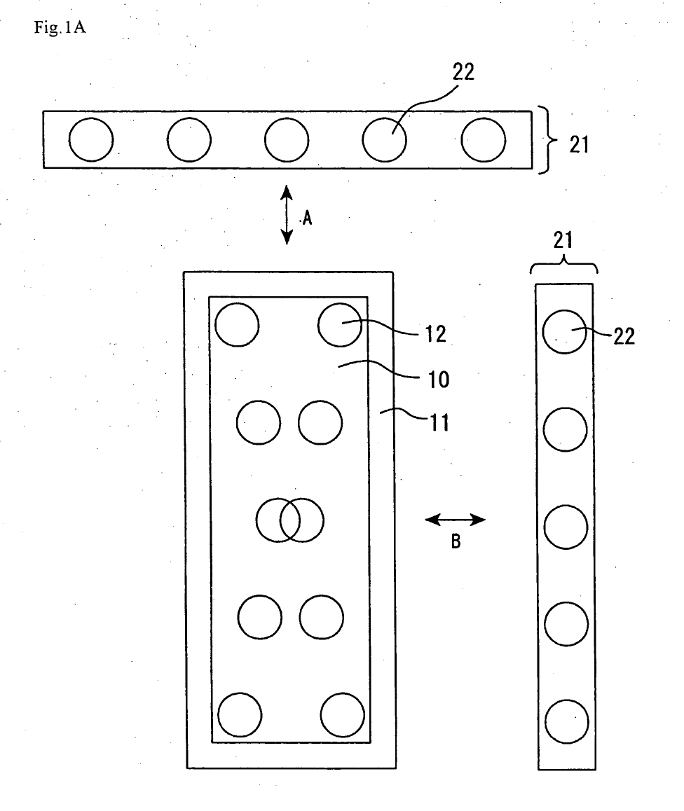

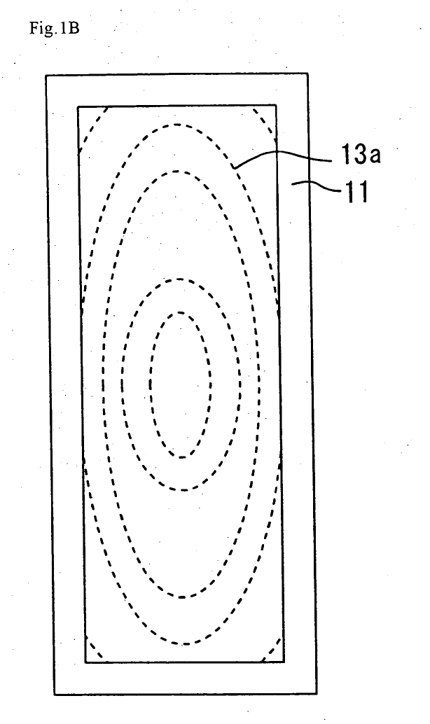

This Embodiment explains a formation of the colored layer (functional film) of the color filter substrate used for a liquid crystal display device. FIG. 1A is a plane view schematically showing a position at which a droplet of liquid material (ink) for functional film is ejected in Embodiment 1. FIG. 1B is a plane view schematically showing, with a contour pattern, a film thickness of a colored layer formed in Embodiment 1. A dotted line in FIG. 1B expresses a contour line of a colored layer 13a.

(1) Formation of Bank

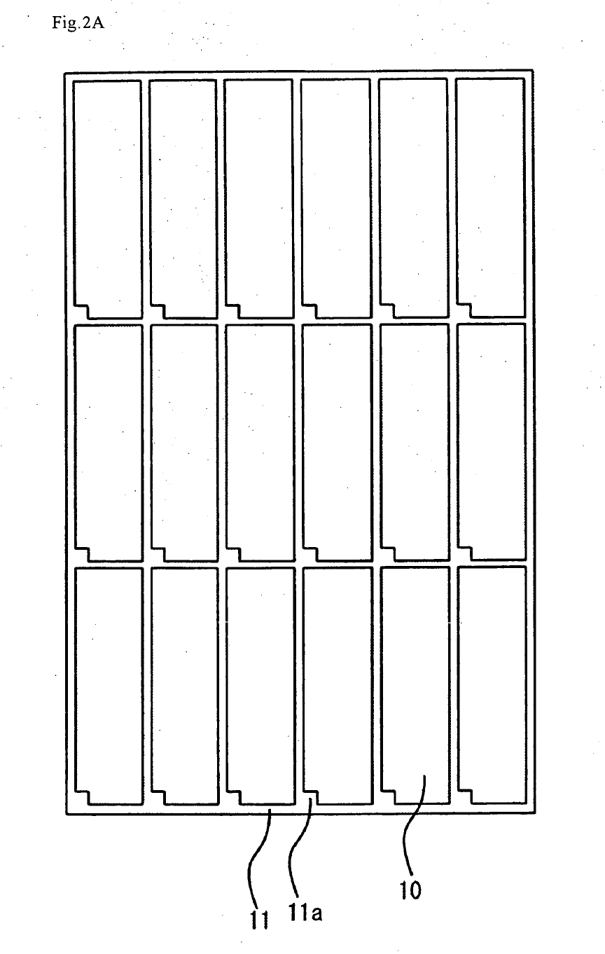

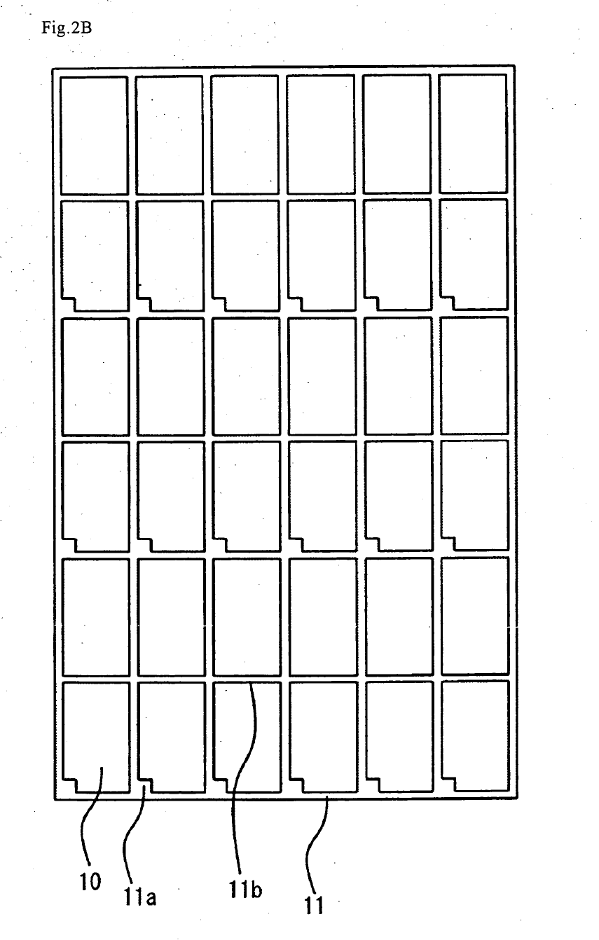

The bank 11 was formed on a substrate 10 before formation of the colored layer 13. The Black matrix (BM) 11 was formed as the bank firstly by applying a photosensitive acrylic resin containing a black pigment on the glass substrate 10 and secondly by exposing and developing the applied resin. The BM 11 was formed in a lattice pattern so that a substantially square-shaped aperture (an area forming the colored layer: 150 μm in length and 450 μm in breadth) was arranged in a dot-matrix pattern. The arrangement of the aperture is not especially limited, and it may be a delta arrangement, for example. The shape of the aperture is not especially limited. For example, a light-shielding part for thin film transistor (TFT) 11a may be formed at one corner of four corners in the aperture, as shown in FIG. 2A; a light-shielding part for storage capacitor wiring 11b may be formed at the center of the aperture, as shown in FIG. 2B; or the corner may be chamfered.

Then, the BM 11 surface was subjected to a plasma treatment with a gas containing a fluorine atom. And thereby, a hydrophobicity was provided with the BM 11, and on the other hand, the glass substrate 10 at the aperture maintained an ink affinity because the substrate was not substituted for the fluorine atom.

(2) Formation of Colored Layer

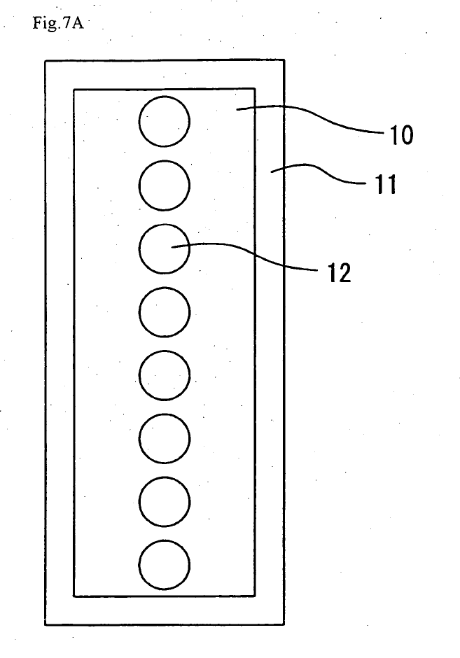

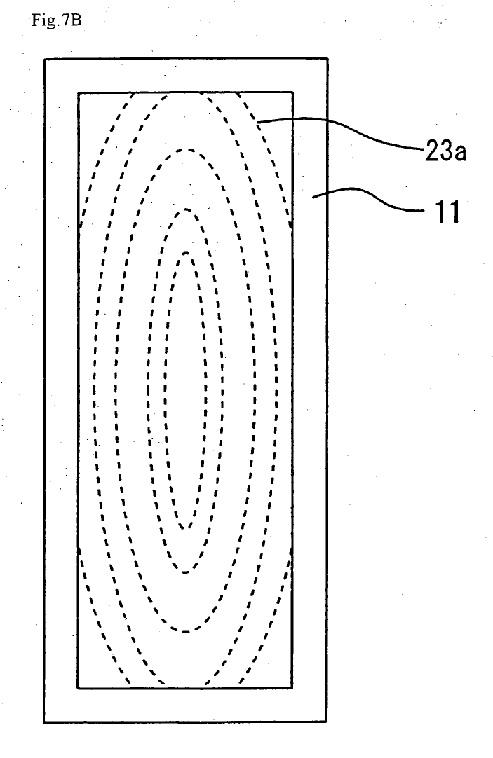

Then, liquid material (the ink) 12 for colored layer was ejected at the aperture of the BM 11 (inside the bank) with an ink jet device. At this time, as shown in FIG. 1A, the ink 12 was ejected at the corner inside the BM 11 while controlling the ejection timing in order that the distance between the droplets of the ink 12 becomes closer as the ink 12 was ejected from the end to the center in the direction of the narrow side of the BM 11. A color dispersion containing a color pigment dispersed in methyl carbitol was used as the ink 12. And 5 pL of droplets of the color dispersion was added dropwise with the ink jet device. All of the droplets of the ink 12 became unified after a total of approximately 400 pL was added dropwise inside the aperture. Then, the ink 12 was solidified by drying to form the colored layer 13a having 1.6 μm in average thickness, 2.0 μm in thickness at the center, and 1.0 μm in thickness at the corner. In the Conventional Embodiment shown in FIG. 7B, the colored layer 23a having 1.6 μm in average thickness, 2.2 μm in thickness at the center, and 0.8 μm thickness at the corner.

In the present Embodiment, the ink 12 spreads to the corner as shown in FIG. 1B, and thereby the colored layer 13a is represented by a contour pattern more extending to the corner inside the BM 11 as compared with the colored layer 23a in the Conventional Embodiment shown in FIG. 7B. Therefore, the generation of the void caused by the corner inside the BM 11 unfilled with the ink 12 can be prevented, which can prevent reduction in display quality of the display device. And in the present Embodiment, the ink was ejected more inward as the ejected point approaches the center of the BM 11, as compared the case where the ink 12 was more ejected linearly at the center in the longitudinal direction of the BM 11, as shown in a Conventional Embodiment in FIGS. 8A and 8B. Therefore, the ink 12 can be prevented from spreading on the BM 11 and thereby mixing with the ink 12 forming adjacent the colored layer 13a, which can prevent reduction in display quality of the display device.

If an ink jet head 21 scanned the substrate parallel to the narrow side of the BM 11 (in the direction of A in FIG. 1A) to eject the ink 12, one or more times of the scanning by the ink jet head 21 needed to be performed in the direction of A in FIG. 1A, because the ink jet head 21 was usually provided with nozzles 22 at regular spaces, though the distance between the droplets in the direction of the narrow side of the BM 11 became narrower toward the center inside the BM 11. On the other hand, the ink jet head 21 scanned the substrate parallel to the long side of the BM 11 (in the direction of B in FIG. 1A) in the present Embodiment. Therefore, the distance between the droplets in the direction of the narrow side of the BM 11 could be varied by controlling the ejection timing. That is, this method allows the distance between the droplets in the direction of the narrow side to be varied by controlling the ejection timing using the distance between the nozzles 22 of the ink jet head 21, without varying the distance between the droplets in the longitudinal direction.

The scanning direction of the ejection device is not especially limited in the present invention. For example, the scanning may be performed parallel to the long side of the bank as in the present Embodiment, parallel to the short side of the bank, or in an oblique direction to the aperture of the bank.

### EMBODIMENT 2

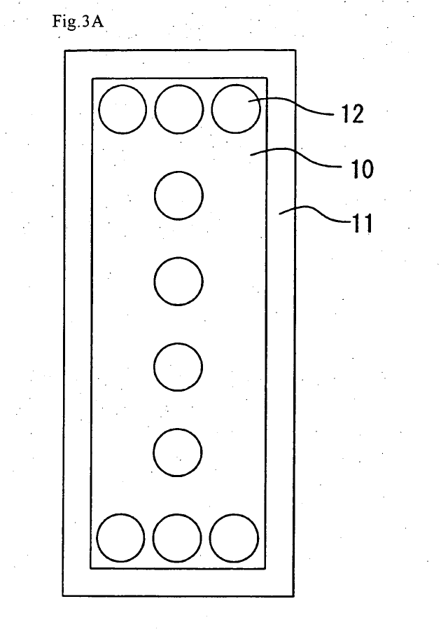

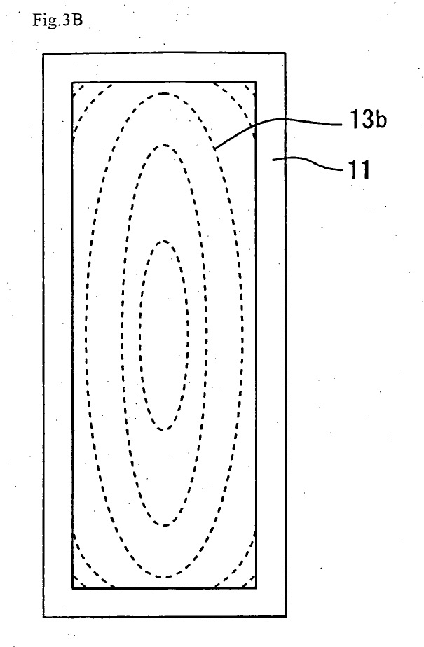

FIG. 3A is a plane view schematically showing a position at which a droplet of liquid material (ink) for functional film is ejected in Embodiment 2. FIG. 3B is a plane view schematically showing, with a contour pattern, a film thickness of a colored layer formed in Embodiment 2. A dotted line in FIG. 3B expresses a contour line of a colored layer 13b.

In the present embodiment, the colored layer 13b having 1.6 μm in average thickness, 2.0 μm in thickness at the center, and 1.1 μm in thickness at the corner was formed in the same manner as in Embodiment 1, except that the ink 12 was ejected at a corner inside the BM 11, and also at the center in the longitudinal direction of the BM 11 drop by drop at regular spaces, as shown in FIG. 3A. The present Embodiment allows the ink 12 to spread to the corner as shown in FIG. 3B, and therefore the same effects as in Embodiment 1 could be obtained.

### EMBODIMENT 3

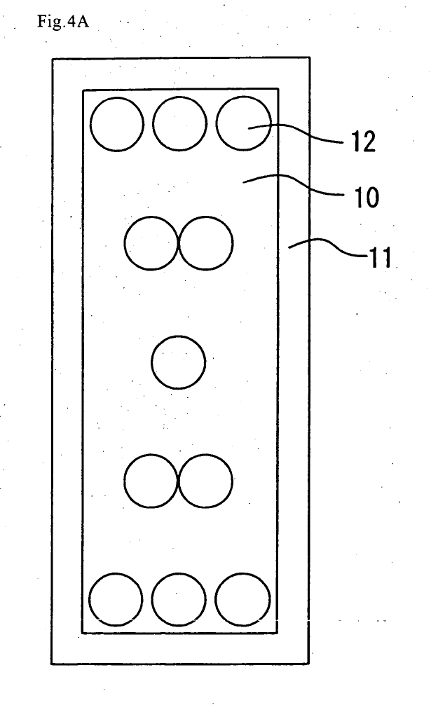

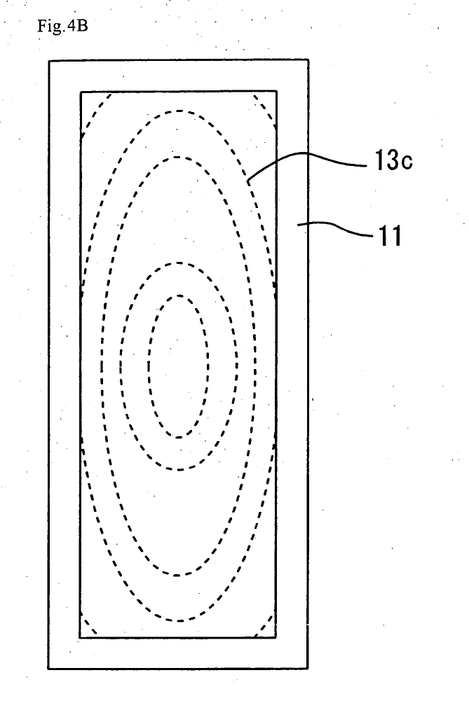

FIG. 4A is a plane view schematically showing a position at which a droplet of liquid material (ink) for functional film is ejected in Embodiment 3. FIG. 4B is a plane view schematically showing, with a contour pattern, a film thickness of a colored layer formed in Embodiment 3. A dotted line in FIG. 3B expresses a contour line of a colored layer 13c.

In the present embodiment, the colored layer 13c having 1.6 μm in average thickness, 2.0 μm in thickness at the center, and 1.1 μm in thickness at the corner was formed in the same manner as in Embodiment 1, except that the ink 12 was ejected at a corner inside the BM 11, and ejected in order that the number of the ejection was gradually decreased from the end of the narrow side inside the BM 11 to the center as shown in FIG. 4A. The present Embodiment allows the ink 12 to spread to the corner as shown in FIG. 4B, and therefore the same effects as in Embodiment 1 could be obtained. And in the present Embodiment, the ejection number of the ink 12 was gradually decreased toward the center inside the BM 11 to make the film thickness at the center inside the colored layer 13c thinner than that in Embodiment 1. Therefore, if the amount per drop of the ink 12 was large for the area of the aperture, a difference in thicknesses at the center and at the edges inside the BM 11 could be effectively decreased, and thereby the color mixing with the ink 12 forming adjacent the colored layer 13c could be effectively prevented. Therefore, such a substrate could improve display quality of the display device.

### EMBODIMENT 4

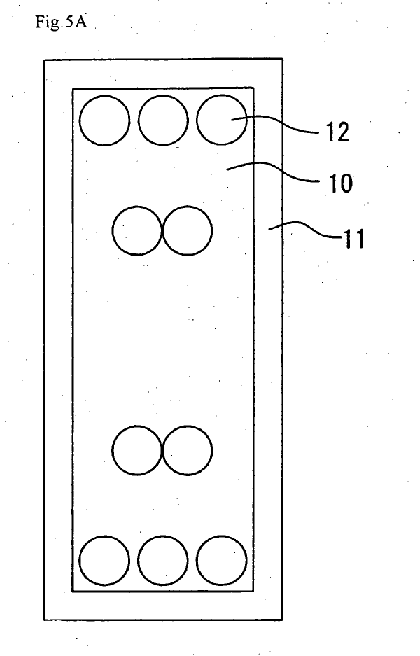

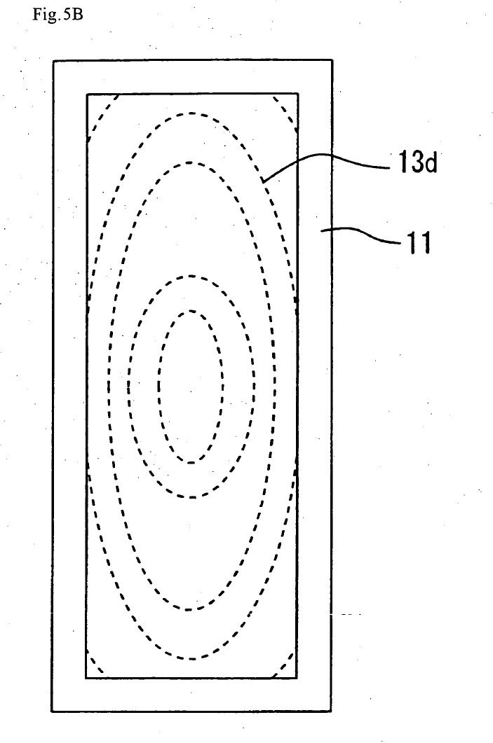

FIG. 5A is a plane view schematically showing a position at which a droplet of liquid material (ink) for functional film is ejected in Embodiment 4. FIG. 5B is a plane view schematically showing, with a contour pattern, a film thickness of a colored layer formed in Embodiment 4. A dotted line in FIG. 5B expresses a contour line of a colored layer 13d.

In the present embodiment, the colored layer 13d having 1.6 μm in average thickness, 1.9 μm in thickness at the center, and 1.1 μm in thickness at the corner was formed in the same manner as in Embodiment 3, except that the ink 12 was not ejected at the center inside the BM 11, as shown in FIG. 5A. The present Embodiment allows the ink 12 to spread to the corner as shown in FIG. 5B, and therefore the same effects as in Embodiment 1 could be obtained. And the same effects as in Embodiment 3 could be obtained because the ejection amount of the ink 12 was gradually decreased toward the center inside the BM 11. Additionally, the film thickness at the center of the colored layer 13d could be thinner than that in Embodiment 3, because the ink 12 was not ejected at the center inside the BM 11.

### EMBODIMENT 5

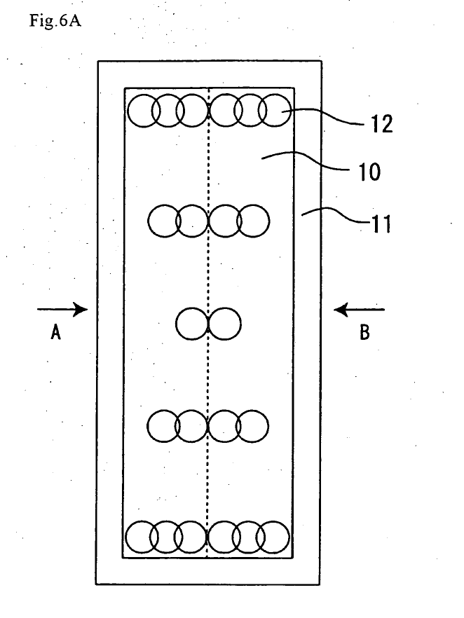

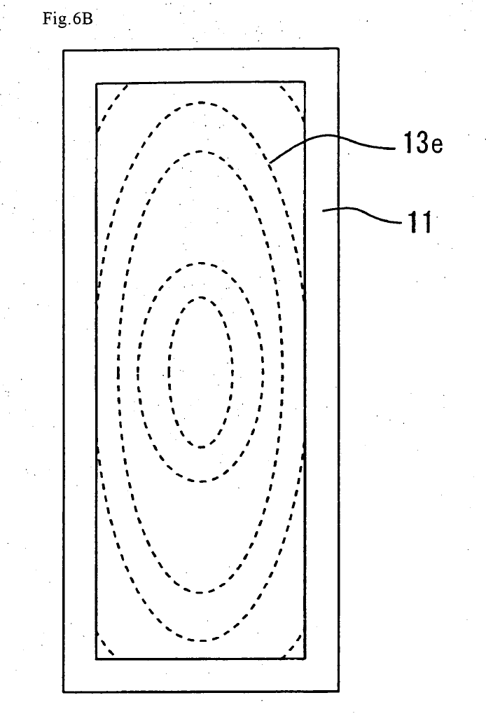

FIG. 6A is a plane view schematically showing a position at which a droplet of liquid material (ink) for functional film is ejected in Embodiment 5. FIG. 6B is a plane view schematically showing, with a contour pattern, a film thickness of a colored layer formed in Embodiment 5. A dotted line in FIG. 6B expresses a contour line of a colored layer 13e.

In the present embodiment, the colored layer 13e having 1.6 μm in average thickness, 2.0 μm in thickness at the center, and 1.2 μm in thickness at the corner was formed in the same manner as in Embodiment 1, except that the ink 12 was ejected inside the BM 11 in two steps, as shown in FIG. 6A. Specifically, the ink 12 was ejected firstly from one side of facing two sides in the BM 11 (from the direction of A in FIG. 6A) to the center inside the BM 11 (to a left area shown with a dotted line in FIG. 6A), and secondly from the other side (from the direction B in FIG. 6A) to the unejected area inside the BM 11 (to a right area shown with the dotted line in FIG. 6A). The droplet ejected into the BM 11 tends to be drawn toward the droplet previously ejected. Therefore, if the colored layer 13e is formed by the ink 12 ejected in one scanning only from the one side, the droplet easily gathers on the side from which the scanning begins, and thereby the liquid amount on facing the other side tends to become smaller. Accordingly, the corner of the colored layer 13e on facing the other side has a thinner film thickness, which might cause the void. On the other hand, in the present embodiment, the ink jet head 21 scanned the substrate in two steps from both sides of the BM 11, which can prevent the colored layer 13e from causing the void due to its thinner film thickness on the facing the other side. Therefore, such a substrate could improve uniformity in display quality of the display device. Also in the present Embodiment, the ink 12 has no need to be added dropwise at the center inside the BM 11, similarly as in Embodiment 4.

1. A substrate for display device having a structure with a functional film partitioned by a bank on the substrate,
the functional film being represented by a contour pattern extending to a corner inside a bank.

2. The substrate for display device according to claim 1,
wherein the functional film is formed from solidified ink.

3. The substrate for display device according to claim 1,
wherein the bank is formed from a hydrophobic material.

4. The substrate for display device according to claim 1,
wherein the bank has a structure with a chamfered corner.

5. The substrate for display device according to claim 1,
wherein the bank is formed from a light-shielding material.

6. A method for manufacturing a substrate for display device having a structure with a functional film partitioned with a bank on the substrate,
the functional film being formed on the substrate by ejecting liquid material for the functional film at least at a corner inside the bank.

7. The method for manufacturing the substrate for display device according to claim 6,
wherein the liquid material is ejected with an ink jet device.

8. The method for manufacturing the substrate for display device according to claim 6,
wherein the liquid material is ejected such that an ejected amount at the center is less than that at the corner inside the bank.

9. The method for manufacturing the substrate for display device according to claim 6,
wherein the liquid material is ejected from a long side if the functional film has an elongated shape.

10. The method for manufacturing the substrate for display device according to claim 6,
wherein the liquid material is ejected in two steps of firstly ejecting the liquid material from one side of facing two sides in the bank to a middle inside the bank, and secondly ejecting the liquid material at an unejected area inside the bank from the other side.

11. A substrate for display device manufactured by the method for manufacturing the substrate for display device according to the claim 6.

12. A color filter substrate consisted of the substrate for display device according to claim 1,
wherein the functional film serves as a colored layer.

13. A color filter substrate consisted of the substrate for display device according to claim 11,
wherein the functional film serves as a colored layer.

14. A thin film transistor array substrate consisted of the substrate for display device according to claim 1,
wherein the functional film serves as a pixel electrode.

15. A thin film transistor array substrate consisted of the substrate for display device according to claim 11,
wherein the functional film serves as a pixel electrode.

16. A liquid crystal display device comprising the color filter substrate according to claim 12.

17. A liquid crystal display device comprising the color filter substrate according to claim 13.

18. A liquid crystal display device comprising the thin film transistor array substrate according to claim 14.

19. A liquid crystal display device comprising the thin film transistor array substrate according to claim 15.

20. An organic electroluminescent display device comprising the substrate for display device according to claim 1.

21. An organic electroluminescent display device comprising the substrate for display device according to claim 11.
